(19) United States
(12) Patent Application Publication
(10) Pub. No.: US 2025/0087977 A1
(43) Pub. Date: Mar. 13, 2025

(54) CABLE PULLING DEVICE

(71) Applicant: Siemens Gamesa Renewable Energy A/S, Brande (DK)

(72) Inventors: Shiva Rahul Tummala, Poranki, Vijayawada (IN); Fathima Zohra, Bangalore (IN)

(21) Appl. No.: 18/727,397

(22) PCT Filed: Jan. 11, 2023
(86) PCT No.: PCT/EP2023/050507

§ 371 Date: Jul. 9, 2024

(30) Foreign Application Priority Data
Jan. 12, 2022 (EP) 22151102.5

(51) Int. Cl. H02G 1/04; H02G 1/08

(52) U.S. Cl. CPC H02G 1/04; H02G 1/08

(57) ABSTRACT

A cable pulling device is provided including two inner plates, two outer plates and one first roller. The two inner plates arranged in the protruding end of the first shaft and two outer plates arranged in the protruding end of the first shaft beside the inner plates. The two inner plates and the two outer plates comprise a pivoting hole, positioning hole and adjusting holes. The inner plates aligned with its corresponding outer plates. Pivoting rods are introduced into pivoting holes to join the inner plates with its corresponding outer plates, consequently able to rotate respect to them.

### CROSS-REFERENCE TO RELATED APPLICATIONS

This application is a national stage of PCT Application No. PCT/EP2023/050507, having a filing date of Jan. 11, 2023, which claims priority to EP application Ser. No. 22151102.5, having a filing date of Jan. 12, 2022, the entire contents both of which are hereby incorporated by reference.

### FIELD OF TECHNOLOGY

The following relates to a cable pulling device for a wind turbine.

### BACKGROUND

Nowadays in the field of renewable energies, the development and innovation in recent decades has resulted in increasing dimensions and power of wind turbines. The dimensions of a wind turbine to another may vary widely, leading to redesigning many components for each wind turbine model. One of the components affected is the cable pulling device, which is required for pulling HV cables from ground to the nacelle of the wind turbine.

For each new wind turbine model, a cable pulling device needs to be designed based on the cable positions in the tower. However, the position of the platforms in the tower are mostly the same for all the models. Furthermore, it would be an advantage to have an adjustable cable pulling device that could be hooked in the middle of the tower structure, not only in the nacelle platform, in case cables needed to be pulled from different points of the tower. Hence, an adjustable cable pulling device that could be used in any wind turbine model and in different positions of the tower regardless the design constraints, variations and dimensions of the tower may avoid the need to design a new cable pulling device for each new wind turbine model.

CN107872028A provides a cable pulling and releasing auxiliary device detachably mounted between any two cross braces of a cable tray. It comprises a bracket with a pair of support members arranged in parallel, rollers are respectively connected to the two supporting members, a bottom plate, a supporting plate vertically connected with the bottom plate. The supporting plate is provided with a plurality of U-shaped holes arranged along of its length direction at intervals, and the ends of the rotating shafts of the rollers are detachably mounted on the supporting plates to change its vertical position.

U.S. Pat. No. 7,419,136B2 discloses a cable pulling device having a roller support structure mounted on a frame comprising a first side plate and a second side plate with a set of rollers between the plates. The structure has an opening in each side of the structure, wherein the cable is introduced in one opening, passing over the rollers and pulled out through the second conduit.

U.S. Pat. No. 11,165,230B1 discloses a roller assembly for facilitating drawing of cable along cable tray of cable tray system for supporting insulated electrical cables or wires throughout building.

A typical disadvantage of such known cable pulling devices is that the position of the rollers is fixed and cannot be adjusted neither in vertical nor horizontal position, or just one of them, which leads to limitations in its use and the need to redesign some components to suit to the design constrains of the place where is going to be used, specifically in this case, for every wind turbine model.

It is therefore a goal of embodiments of the present invention to provide a cable pulling device that may be adjusted to any wind turbine model, regardless the different design constrains between them. The rollers of the cable pulling device configured to be adjustable in vertical position, so it may be used in any wind turbine model. The rollers of the cable pulling device may further be configured to be adjustable in horizontal position.

A further goal of embodiments of the invention is to provide a cable pulling device that may be hooked to the tower structure, so the cable may be pulled from different points along the tower during its construction.

### SUMMARY

An aspect relates to a cable pulling device comprised of two inner plates, two outer plates and a first roller with a first shaft, two pivoting rods and two adjusting rods. The first shaft configured to pass through the first roller and its protruding ends are configured to protrude from the first roller. Each of the two inner plates have a pivoting hole, a positioning hole and at least two adjusting holes, in the same way, each of the two outer plates have a pivoting hole, a positioning hole and an adjusting hole, thus the two inner plates and the two outer plates have corresponding matching holes, wherein the holes of the two inner plates are configured to correspond to the holes of the two outer plates. Therefore, the pivoting holes of the two inner plates corresponds with the pivoting holes of the two outer plates, the positioning hole of the two inner plates correspond with the positioning hole of the two outer plates. For the adjusting holes, one of the at least two adjusting holes of each inner plate is configured to be aligned to the adjusting hole of its corresponding outer plate, as each outer plate may have only one adjusting hole.

Each of the two inner plates configured to be arranged at one of the protruding ends of the first shaft of the first roller, one inner plate configured to be arranged at one protruding end and the other inner plate configured to be arranged at the other protruding end of the first shaft. Subsequently, each of the two outer plates configured to be arranged at one protruding end of the first shaft of the first roller beside the two inner plates, hence, the first roller configured to be positioned between the two inner plates and the two inner plates configured to be positioned between the two outer plates.

The two inner plates configured to be arranged at the first shaft by introducing the protruding ends of the first shaft through the positioning hole of the corresponding inner plate, subsequently, the two outer plates configured to be arranged by introducing the protruding ends of the first shaft through the positioning hole of the corresponding outer plate. Consequently, the holes of the two inner plates configured to be aligned with the holes of the two outer plates. The protruding ends of the first shaft configured to be supported in the positioning holes of the two inner plates and the two outer plates and configured to be secured on the outer part of the two outer plates with mechanical means, wherein mechanical means configured to be arranged at the protruding ends to secure the first shaft of the first roller to the two outer plates. The mechanical means may be a washer and a nut. Additional mechanical means may also be configured to be arranged at the first shaft to arrest and support the first roller. The additional mechanical means could be bearings.

In order to join and secure the inner plate with its corresponding outer plate, each pivoting hole of the two inner plates is configured to be aligned with the corresponding pivoting hole of its corresponding outer plate. Hence, to join and secure them the cable pulling device may further comprise two pivoting rods. Each pivoting rod configured to be introduced into the pivoting holes to join one inner plate with its corresponding outer plate, consequently, the other pivoting rod configured to be introduced into the pivoting holes to join the other inner plate with its corresponding outer plate, in such a way that each inner plate is configured to be rotated in respect to its corresponding outer plate, thereby enabling the rotation of each inner plate in respect of its corresponding outer plate. The pivoting hole is configured to act as a hinge between the inner plates and outer plates, therefore the two inner plates are configured to be rotated in respect to its corresponding outer plate, which may have fixed position. As the two inner plates have rotational flexibility consequently first roller is configured to be moved in the vertical position. The pivoting rods may be any of shaft, screw, bolt or pin. The pivoting rod is configured to be secured with mechanical means to ensure the fixation with the plates.

Each inner plate is configured to be rotated in respect to its corresponding outer plate, wherein one of the at least two adjusting holes of each inner plate is configured to be aligned with the adjusting hole of its corresponding outer plate and wherein each adjusting rod is configured to be introduced into the aligned adjusting holes to fix the position of each inner plate in respect of its corresponding outer plate.

Each adjusting rod corresponds to one inner plate and are configured to be interchangeable between the at least two adjusting holes of its corresponding inner plate thereby adjusting the vertical position of the first roller.

In an embodiment, the at least two adjusting holes of each inner plate may be configured to be arranged in linear or semicircular alignment.

The linear and semicircular alignment of the at least two adjusting holes allow different positions of the inner plates to vary the vertical position of the first roller.

In an embodiment, the adjusting rods are any of shaft, screw, bolt or pin.

In an embodiment, the positioning holes of the two inner plates and the positioning holes of the two outer plates have sawtooth shape, having at least two teeth.

Generally, the number of teeth may be three, having the first roller three different horizontal positions. In embodiments of the present invention, the sawtooth shape is a waveform having a pattern wherein the teeth may have a semicircular, u-shaped, square or trapezoidal shape.

In an embodiment, the shape of the teeth of positioning holes of the two inner plates and the positioning holes of the two outer plates is any of semicircular, u-shaped, square or trapezoidal.

In an embodiment, the cable pulling device further comprise mechanical means configured to secure the first shaft to the two outer plates, the mechanical means are configured to be arranged at the protruding ends of the first shaft of the first roller.

The mechanical means may be a washer and a nut. Additional mechanical means may also be configured to be arranged at the first shaft to arrest and support the first roller. The additional mechanical means could be bearings.

In an embodiment, the first roller is hollow or solid.

In case of a hollow first roller, the first shaft may be configured to pass through the first roller and the protruding ends of its first shaft may be configured to protrude it. Otherwise, in case of a solid first roller, the first shaft may be configured to be placed on each end or face of the first roller and it may be configured to be supported on the positioning holes of the two inner plates and two outer plates and may be configured to be secured on the outer part of the outer plates with mechanical means. The roller material may be Polyoxymethylene (POM) or any metal.

In an embodiment, the shape of the two outer plates is any of rectangular or square and the edges are rounded or right-angled.

In an embodiment, each of the two outer plates may have attached along an additional plate with an elongated hole.

The two additional plates may be added in case an additional load may be needed, to balance the weight and the loads of the cable pulling device.

In an embodiment, the cable pulling device further comprise hooking elements, each hooking element configured to be arranged between the inner plate and its corresponding outer plate, wherein the hooking elements are any of hook, L-shaped rigid bar or crow bar.

The cable pulling device may need to be hooked at a specific point of the tower structure or a wall, therefore two hooking elements may be added. Each hooking element may be arranged between one of the two inner plates and its corresponding outer plate, thus having one hooking element on each side of the cable pulling device.

The cable pulling device may not be limited to being placed into a planar surface, by having hooking elements it might be configured to be hooked in a part of the structure of the wind turbine during construction.

In an embodiment, the cable pulling device may further comprise a second roller, which may comprise a second shaft configured to pass through it and which protruding ends may be configured to protrude from the second roller. It may further comprise two additional inner plates, two additional pivoting rods and additional two adjusting rods. The two additional inner plates may comprise an additional pivoting hole, an additional positioning hole and at least two additional adjusting holes. In total the cable pulling device may have four inner plates, two inner plates for the first roller and two additional inner plates for the second roller. Each of the two additional inner plates may be configured to be arranged at each protruding end of the second shaft of the second roller.

Each of the two outer plates may further comprise two additional pivoting holes, two additional positioning holes and two additional adjusting holes. Each outer plate may be configured to be arranged at the protruding ends of the first and second shafts of the first roller and second roller beside the corresponding inner plates, being the outer plate common for the inner plates. Each additional pivoting hole of each additional inner plate may be configured to be aligned with the corresponding additional pivoting hole of its corresponding outer plate.

The additional pivoting rod may be configured to be introduced into the pivoting holes to join the inner plate with the outer plate and correspondingly the pivoting rod may be configured to be introduced into the pivoting holes to join the inner plate with the outer plate. The pivoting rod may be configured to be introduced into the pivoting holes to join the inner plate with the outer plate, in such a way that each inner plate may be configured to be rotated in respect to its corresponding outer plate.

One of the at least two additional adjusting holes of each additional inner plate may be configured to be aligned with the additional adjusting hole of its corresponding outer plate and wherein each additional adjusting rod may be configured to be introduced into the aligned adjusting holes to fix the position of each additional inner plate in respect of its corresponding outer plate.

The two outer plates may be longer and may have a rectangular shape. In each outer plate, the holes may be distributed at opposite sides and may be configured to be arranged in such a way that could be aligned with its corresponding two inner plates. As described above, two inner plates may be configured to be arranged at the protruding ends of the first shaft of the first roller and subsequently, the other two additional inner plates may be arranged in the protruding ends of the second shaft of the second roller. One outer plate may be configured to be arranged at the protruding ends of the first and second shafts of the first roller and the second roller beside the corresponding inner plate and the additional inner plate, being the outer plate common for those inner plate and additional inner plate, correspondingly.

In the same way, the other outer plate may be configured to be arranged at the protruding ends of the first and second shafts of the first roller and the second roller beside the corresponding inner plate and additional inner plate, being the outer plate common for those inner plate and additional inner plate. The protruding ends of the first and second shafts of the first and second roller may be configured to be supported in the corresponding positioning holes of the four inner plates and the two outer plates and may be configured to be secured on the outer part of the outer plates with mechanical means, such as a washer and a nut. Additional mechanical means may also be configured to be arranged at the second shaft to arrest and support the second roller. The additional mechanical means could be bearings.

The pivoting hole of each of the four inner plates may be aligned with the pivoting hole of its corresponding outer plate. There are four pivoting rods, wherein each pivoting rod may be configured to be introduced into the pivoting holes to join the inner plate to its corresponding outer plate, in such a way that each inner plate may be configured to be rotated in respect to its corresponding outer plate.

The vertical position of the first roller may be configured to be adjusted due to the rotation of the two inner plates in respect of the two outer plates. In order to fix the position of the two inner plates in respect with the two outer plates, two adjusting rods are needed. Each inner plate may have one adjusting rod, therefore for a first roller there are two adjusting rods. Each adjusting rod corresponds to one inner plate and may be configured to be interchangeable between the at least two adjusting holes of its corresponding inner plate.

The two inner plates and two additional inner plates may be configured to be rotated in respect to its corresponding two outer plates in the same direction and fixed in the same position and one of the at least two adjusting holes of each inner plate may be configured to be aligned with the adjusting hole of the corresponding outer plate. Hence, each of the two adjusting rods are configured to be introduced into the adjusting hole of the inner plate that is aligned with the adjusting hole of the corresponding outer plate to fix the position of each inner plate in respect of its corresponding outer plate. Each adjusting hole may be configured to correspond to a different vertical position for the first and second roller. There could be at least two adjusting holes or a plurality of adjusting holes in the two inner plates and two additional inner plates, thus having several vertical positions. The at least two adjusting holes of the two inner plates may be arranged in linear or semi-circular alignment. The adjusting rods may be any of shaft, screw, bolt or pin.

In order to change the first roller and second roller in horizontal position, the positioning holes of the two inner plates, the two additional inner plates and the two outer plates may have a sawtooth shape, having at least two teeth, being each tooth a different position. Generally, the number of teeth may be three, having the first and second roller three different horizontal positions. The teeth shape may be any of semicircular, u-shaped, square or trapezoidal shape. It may be an advantage that the first and second roller may be configured to be adjusted in the horizontal direction, as in some cases, the first and second rollers may need to be closer or further, e.g., distance to a wall. When the cable pulling device is near to a wall, the first and second roller may be configured to be placed further using the last position of the positioning holes.

The first roller and second roller may be a hollow or solid component. In case of a hollow first and second roller, the first and second shaft may be configured to pass through the first roller and second roller and the protruding ends of its first and second shaft may be configured to protrude them. Furthermore, two bearings may be configured to be placed at each first and second shaft to arrest and support the first roller and second roller. On the other hand, in case the first roller and second roller may be a solid component, a first and second shaft may be configured to be placed on each end or face of the first roller and second roller and it may be configured to be supported on the positioning holes of the two inner plates, two additional inner plates and two outer plates and may be configured to be secured on the outer part of the outer plates with mechanical means. The roller material may be Polyoxymethylene (POM) or any metal.

In general, the shape of the two inner plates and the two additional inner plates may be square with rounded or right-angled edges. The two outer plates may have different shapes, being the shape of the outer plates any of square, rectangular and the edges may be rounded or right-angled. Furthermore, the two outer plates may be longer and may have a rectangular shape as it may be configured to hold one inner plate and one additional inner plate per plate, which may be arranged at the ends of the outer plates on opposite sides.

The cable pulling device may need to be hooked at a specific point of the tower structure or a wall, therefore two hooking elements may be added. In case of just having the first roller, each hooking element may be configured to be arranged between one of the two inner plates and its corresponding outer plate, thus having one hooking element in each side of the cable pulling device. On the other hand, in case of having the first and second roller, each of the two hooking elements only may be configured to be arranged between one of the two inner plates of the first roller and its corresponding outer plate, thus having one hooking element in each side of the cable pulling device. The two hooking elements may be any of hook, L-shaped rigid bar or crowbar.

Furthermore, the two additional plates may be configured to be arranged along the two outer plates on the opposite side of the two hooking elements. The two additional plates may be added in case an additional load may be needed, to balance the weight and the loads of the cable pulling device when the two hooking elements may be arranged. The additional plates may have an elongated hole.

As the two inner plates and two additional inner plates may be configured to rotate in respect to the two outer plates, the vertical position of the first roller and second may be adjusted. Likewise, by changing the first roller and second of positioning hole, the horizontal position may be adjusted. A further advantage is that due to arranging the two hooking elements between the two inner plates and the two outer plates, the cable pulling device may not be limited to be placed into a planar surface, it might be hooked in a part of the structure of the wind turbine during construction.

### BRIEF DESCRIPTION

Some of the embodiments will be described in detail, with references to the following Figures, wherein like designations denote like members, wherein:

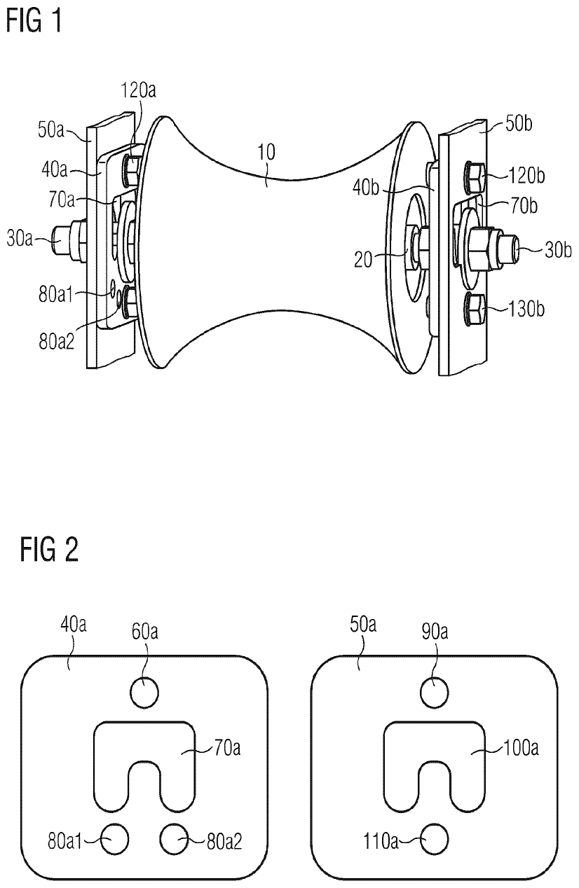

FIG. 1 shows a perspective view of a cable pulling device according to an example:

FIG. 2 shows a plain view of an inner plate and an outer plate according to an example:

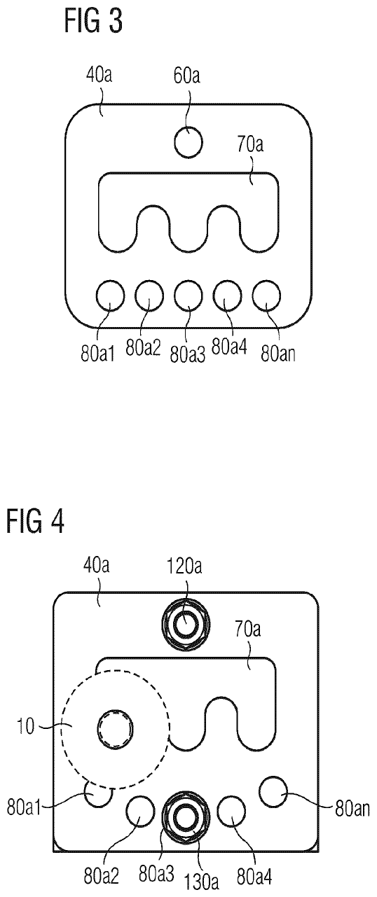

FIG. 3 shows a plain view of an inner plate with a positioning hole with sawtooth shape with U-shape teeth and a plurality of adjusting holes with linear alignment according to an example:

FIG. 4 shows a plain view of an inner plate with a first roller supported in the positioning hole according to an example:

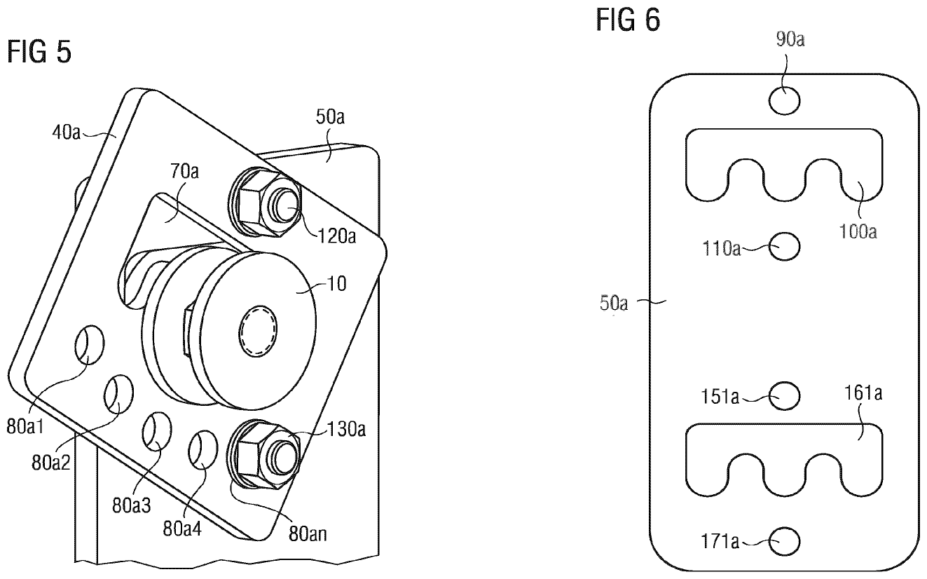

FIG. 5 shows perspective view of an inner plate rotated in respect of an outer plate with a pivoting rod and an adjusting rod according to an example:

FIG. 6 shows a plain view of an outer plate according to an example:

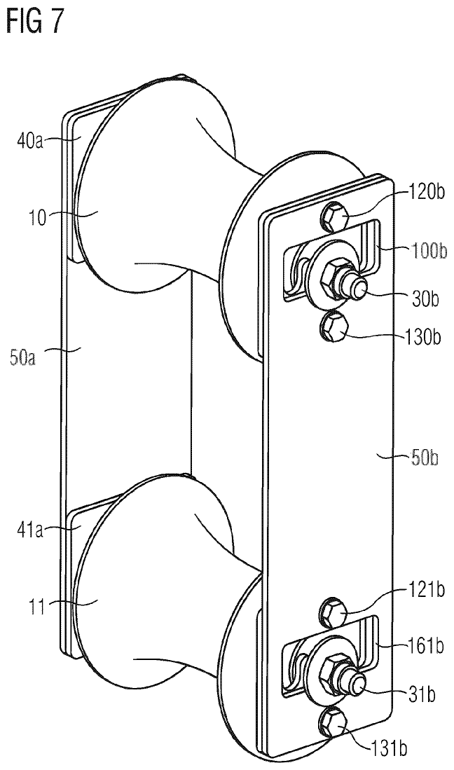

FIG. 7 shows a perspective view of a cable pulling device with a first roller and a second roller according to an example; and

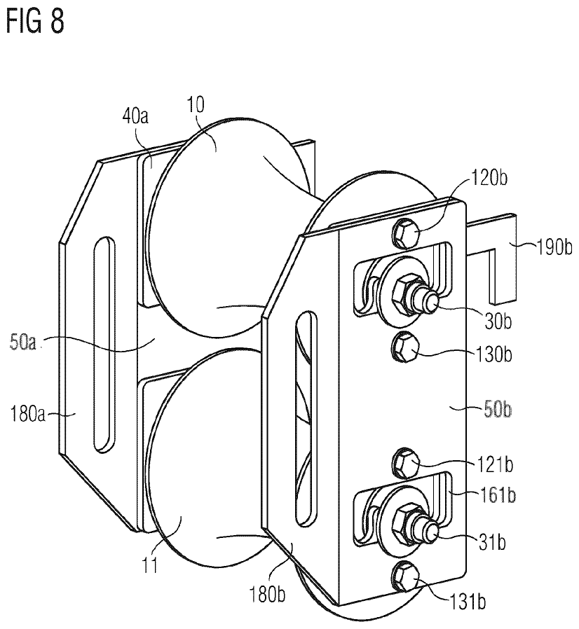

FIG. 8 shows a perspective view of a cable pulling device with additional plates arranged along the two outer plates and two hooking elements arranged between the two inner plates and the two outer plates according to an example.

### DETAILED DESCRIPTION

FIG. 1 shows a perspective view of a cable pulling device that may comprise a first roller (10), two inner plates (40a, 40b) and two outer plates (50a, 50b). The first roller (10) may be hollow and has a first shaft (20) that passes through it and which protruding ends (30a, 30b) may protrude from the first roller (10). The first roller (10) has additional mechanical means, such as bearings, arranged in the first shaft (20) configured to arrest and support the first roller (10). The two inner plates (40a, 40b) may be configured to be arranged at the protruding ends (30a, 30b) of the first shaft (20). The two outer plates (50a, 50b) may be arranged in the protruding ends (30a, 30b) besides the two inner plates (40a, 40b), correspondingly. The protruding ends (30a, 30b) of the first shaft (20) may be configured to be secured to the outer part of the two outer plates (50a, 50b) with mechanical means. Two pivoting rods (120a, 120b) may be configured to join and secure each of the two inner plates (40a, 40b) with its corresponding outer plate (50a, 50b).

FIG. 2 shows plain view of an inner plate (40a) and an outer plate (50a). The inner plate (40a) may have a pivoting hole (60a), a positioning hole (70a) and at least two adjusting holes (80a1, 80a2). The outer plate (50a) may have a pivoting hole (90a), a positioning hole (100a) and an adjusting hole (110a). The holes of the inner plate (40a) may correspond to matching holes with the holes of the outer plate (50a).

FIG. 3 shows a plain view of an inner plate (40a) with a positioning hole (70a) with sawtooth shapes with U-shape teeth. Each tooth of the positioning hole (70a) may be a different horizontal position. Generally, there are three different horizontal positions in the positioning hole (70a), nevertheless it may have at least two teeth or a plurality. The inner plate (40a) may have a plurality of adjusting holes (80a1, 807a2, 80a3, 80a4 . . . 80an) with linear alignment.

FIG. 4 shows a plain view of an inner plate (40a) that may have a first roller (10) supported in the positioning hole (70a). The positioning hole (70a) may have three teeth; thus, the first roller (10) may have three different horizontal positions.

FIG. 5 shows perspective view of an inner plate (40a) rotated in respect of an outer plate (50a). The pivoting hole (60a) of the inner plate (40a) may be aligned with the pivoting hole (90a) of the outer plate (50a). The pivoting rod (120a) may join and secure the inner plate (40a) with the outer plate (50a). The pivoting rod (120a) may act as a hinge; thus, the inner plate (40a) may be rotated in respect with the outer plate (50a). One adjusting hole (80an) of the plurality of the adjusting holes (80a1, 807a2, 80a3, 80a4 . . . 80an) of the inner plate (40a) may be aligned with the adjusting hole (110a) of the outer plate (50a). The adjusting rod (130a) may be configured to be introduced into the aligned adjusting holes (80an, 110a) to fix the position of the inner plate (40a) in respect of the outer plate (50a).

FIG. 6 shows a plain view of an outer plate (50a), it may have two pivoting holes (90a, 151a), two positioning holes (100a, 161a) and two adjusting holes (110a, 171a).

FIG. 7 shows a perspective view of a cable pulling device with a first roller (10) and a second roller (11). The inner plates (40a, 40b) may be configured to be arranged at the protruding ends (30a, 30b) of the first shaft (20) that may pass through the first roller (10). The inner plates (41a, 41b) may be configured to be arranged at the protruding ends (31a, 31b) of the second shaft (21) that may pass through the second roller (11). The outer plate (50a) may be configured to be arranged at the protruding ends (30a, 31a) of the first shaft (20) and second shaft (21) beside the inner plate (40a) and the additional inner plate (41a). The outer plate (50b) may be configured to be arranged at the protruding ends (30b, 31b) of the first shaft (20) and second shaft (21) beside the inner plate (40b) and the additional inner plate (41b). The pivoting rod (120b) may be configured to join and secure the additional inner plate (40b) with the outer plate (50b), as well as the pivoting rod (121b) may be configured to join and secure the additional inner plate (41b) with the outer plate (50b), being the outer plate (50b) common for the inner plate (40b) and the additional inner plate (41b) as shown. The adjusting rods (130b, 131b) may be configured to fix the position of the additional inner plates (40b, 41b) in respect of the outer plate (50b) as shown.

FIG. 8 shows a perspective view of a cable pulling device comprising a first roller (10) and a second roller (11) as described in FIG. 7. Each of the two outer plates (50a, 50b) may have attached along an additional plate (180a, 180b) with an elongated hole. Two hooking elements (190a, 190b) may be configured to be arranged at the opposite side of the additional plates (180a, 180b). The hooking element (190a) may be configured to be arranged between the inner plate (40a) and the outer plate (50a) and the hooking element (190b) may be configured to be arranged between the inner plate (40b) and the outer plate (50b), as shown.

The horizontal position of first roller (10) may configured to be changed by changing the first roller (10) of position in the positioning hole (70a, 70b, 100a, 100b) of the inner plates (40a, 40b) and outer plates (50a, 50b). The positioning holes (70a, 70b, 100a, 100b) may have sawtooth shape, having at least two teeth, being each tooth a different position, as shown in FIG. 4.

To adjust the vertical position of the first roller (10), the inner plates (40a, 40b) may be configured to rotate in respect of the outer plates (50a, 50b). Two pivoting rods (120a, 120b) may be configured to join and secure each of the two inner plates (40a, 40b) with its corresponding outer plate (50a, 50b), as shown in the FIG. 1. Each of the two pivoting rods (120a, 120b) may be configured to be introduced into the pivoting hole (60a, 60b) of its corresponding inner plate (40a, 40b) and outer plate (50a, 50b). The pivoting rod (120a) may act as a hinge, thus the inner plate (40a) may be rotated in respect with the outer plate (50a), as well as the pivoting rod (120b) may be configured to enable the inner plate (40b) to be rotated in respect with the outer plate (50b). To fix the position of the inner plates (40a, 40b) with its corresponding outer plate (50a, 50b) after being rotated, two adjusting rods (130a, 130b) may be needed. The two adjusting rods (130a, 130b) may be configured to be pulled out. The inner plates (40a, 40b) may be configured to be rotated in respect of the outer plates (50a, 50b). Subsequently, one of the at least two adjusting holes (80a1, 80a2, 80b1, 80b2) of each inner plate (40a, 40b) may be configured to be aligned with the adjusting hole (110a, 110b) of the corresponding outer plate (50a, 50b) and finally each of the two adjusting rods (130a, 130b) may be configured to be introduced into the adjusting holes that are aligned, as shown in FIG. 5.

The cable pulling device may comprise two rollers. Particularly, a first roller (10) and a second roller (11), two inner plates and two additional inner plates (40a, 40b, 41a, 41b) and two outer plates (50a, 50b). The additional plates (180a, 180b) may be configured to be arranged as described in FIG. 7. The horizontal position of the first roller (10) may be configured to be changed in the same way as described above in respect of the two outer plates (50a, 50b). Likewise, to change the horizontal position of the second roller (11), the second roller (11) may be configured to be supported in another position of the positioning holes (161a, 161b) of the two additional inner plates (41a, 41b) and the corresponding outer plates (50a, 50b).

The vertical position of the first roller (10) may be configured to be adjusted in the same way as described for the first embodiment in respect of the two outer plates (50a, 50b). Similarly, the vertical position of the second roller (11) may be configured to be adjusted by pulling out the additional adjusting rods (131a, 131b), the inner plates (41a, 41b) configured to be rotated in respect to the two outer plates (50a, 50b) and the at least two adjusting holes (81a1, 81a2, 81b1, 81b2) of each additional inner plate (41a, 41b) configured to be aligned with the adjusting hole (171a, 171b) of its corresponding outer plate (50a, 50b). Finally, the adjusting rods (131a, 131b) may be configured to be introduced into the adjusting holes that may be aligned.

The cable pulling device may further comprising two hooking elements (190a, 190b). Each hooking element (190a, 190b) may be configured to be arranged between one of the two inner plates (40a, 40b) and its corresponding outer plate (50a, 50b), thus having one hooking element (190a, 190b) in each side of the cable pulling device. In case of having two rollers, there may be only two hooking elements (190a, 190b) and it may be configured to be arranged between the two inner plates (40a, 40b) of the first roller (10) and its corresponding outer plate (50a, 50b), thus having one hooking element (190a, 190b) in each side of the cable pulling device, as shown in FIG. 8. The two hooking elements (190a, 190b) may be any of hook, L-shaped rigid bar or crowbar. By having two hooking elements (190a, 190b), the cable pulling device may not be limited to be placed in a planar surface, as it may be hooked in a structure such as a wall, e.g., during the construction of the tower, if there is a need to install cables, the cable pulling device may be hooked in a wall of the tower and from that point the cable may be pulled.

Furthermore, two additional plates (180a, 180b) may be configured to be arranged along the two outer plates (50a, 50b) in the opposite side of the two hooking elements (190a, 190b). The two additional plates (180a, 180b) may be added in case an additional load may be needed, to balance the weight and the loads of the cable pulling device when the two hooking elements (190a, 190b) are present, as shown in FIG. 8. The additional plates may have (180a, 180b) an elongated hole.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A cable pulling device comprising:
a first roller,
a first shaft configured to pass through the first roller and its protruding ends configured to protrude from the first roller,
two inner plates,
two outer plates,
two pivoting rods, and
two adjusting rods,
wherein each of the two inner plates (40a, 40b) include a pivoting hole, a positioning hole and at least two adjusting holes and wherein the two inner plates configured to be arranged at the first shaft by introducing the protruding ends of the first shaft through the positioning hole of the corresponding inner plate; and
wherein each of the two outer plates include a pivoting hole, a positioning hole and an adjusting hole and wherein the two outer plates configured to be arranged by introducing the protruding ends of the first shaft through the positioning hole of the corresponding outer plate; and
wherein the pivoting hole of each inner plate configured to be aligned with the corresponding pivoting hole of its corresponding outer plate; and
wherein the pivoting rod configured to be introduced into the pivoting holes to join the inner plate with the outer plate and correspondingly the pivoting rod configured to be introduced into the pivoting holes to join the inner plate with the outer plate, in such a way that each inner plate configured to be rotated in respect to its corresponding outer plate and wherein one of the at least two adjusting holes of each inner plate is configured to be aligned with the adjusting hole of its corresponding outer plate and wherein each adjusting rod is configured to be introduced into the aligned adjusting holes to fix the position of each inner plate in respect of its corresponding outer plate.

2. The cable pulling device according to claim 1, wherein the at least two adjusting holes of each inner plate configured to be arranged in linear or semicircular alignment.

3. The cable pulling device according to claim 1, wherein the adjusting rods are any of shaft, screw, bolt or pin.

4. The cable pulling device according to claim 1, wherein the positioning holes of the two inner plates and the positioning holes of the two outer plates have sawtooth shape, having at least two teeth.

5. The cable pulling device according to the claim 4, wherein the shape of the teeth of positioning holes of the two inner plates and the positioning holes of the two outer plates is any of semicircular, u-shaped, square or trapezoidal.

6. The cable pulling device according to claim 1, further comprising mechanical means configured to secure the first shaft to the two outer plates, the mechanical means configured to be arranged at the protruding ends of the first shaft of the first roller.

7. The cable pulling device according to claim 1, wherein the first roller is hollow or solid.

8. The cable pulling device according to claim 1, wherein the shape of the two outer plates is any of rectangular or square and the edges are rounded or right-angled.

9. The cable pulling device according to claim 1, wherein the each of the two outer plates have attached along an additional plate with an elongated hole.

10. The cable pulling device according to claim 1, further comprising a hooking elements, wherein the hooking element is configured to be arranged between the inner plate and its corresponding outer plate, and the hooking element is configured to be arranged between the inner plate and its corresponding outer plate, wherein the hooking elements are any of hook, L-shaped rigid bar or crowbar.

11. The cable pulling device according to claim 1, further comprise:
a second roller
a second shaft configured to pass through the second roller and which protruding ends configured to protrude from the second roller,
two additional inner plates comprising an additional pivoting hole, an additional positioning hole and at least two additional adjusting holes,
two additional pivoting rods,
two additional adjusting rods,
wherein each of the two additional inner plates configured to be arranged at each protruding end of the second shaft of the second roller; and
wherein each of the two outer plates further comprising two additional pivoting holes, two additional positioning holes and two additional adjusting holes, and
wherein the outer plate configured to be arranged at the protruding ends of the first and second shafts of the first roller and second roller beside the corresponding inner plate and additional inner plate, being the outer plate common for the inner plate and additional inner plate, and
and the outer plate configured to be arranged at the protruding ends of the first shaft and second shaft of the first roller and the second roller beside the corresponding inner plate and the additional inner plate, being the outer plate common for the inner plate and the additional inner plate; and
wherein the additional pivoting hole of each additional inner plate configured to be aligned with the corresponding additional pivoting hole of its corresponding outer plate; and
wherein the additional pivoting rod configured to be introduced into the additional pivoting holes to join the additional inner plate with the outer plate and correspondingly the pivoting rod configured to be introduced into the additional pivoting holes to join the additional inner plate with the outer plate, and
wherein the additional pivoting rod configured to be introduced into the pivoting holes to join the inner plate with the outer plate and
correspondingly the additional pivoting rod configured to be introduced into the additional pivoting holes to join the additional inner plate with the outer plate, in such a way that each inner plate and additional inner plate configured to be rotated in respect to its corresponding outer plate; and
wherein one of the at least two additional adjusting holes of each additional inner plate is configured to be aligned with the additional adjusting hole of its corresponding outer plate and wherein each additional adjusting rod is configured to be introduced into the aligned adjusting holes to fix the position of each additional inner plate in respect of its corresponding outer plate.

12. The cable pulling device according to claim 11, further comprising mechanical means configured to secure the second shaft to the two outer plates, the mechanical means configured to be arranged at the protruding ends of the second shaft of the second roller.
